(19) United States
(12) Patent Application Publication
(10) Pub. No.: US 2010/0122496 A1
(43) Pub. Date: May 20, 2010

(54) Sliding Panel For A Sliding Window Assembly

(76) Inventor: David W. Lahnala, Adrian, MI (US)

Correspondence Address: HOWARD & HOWARD ATTORNEYS PLLC, 450 West Fourth Street, Royal Oak, MI, 48067, US

(21) Appl. No.: 12/621,250

(22) Filed: Nov. 18, 2009

Related U.S. Application Data
(60) Provisional application No. 61/199,704, filed on Nov. 19, 2008.

(51) Int. Cl. E05F 11/48; E06B 3/46

(52) U.S. Cl. 49/360; 49/506

(57) ABSTRACT

A sliding panel for use in a sliding window assembly has a bottom edge in sliding engagement with the sliding window assembly. The sliding panel includes at least one bracket coupled to the sliding panel. A cable has a first end and a second end spaced from the first end with a body portion disposed therebetween with at least one of the first end, the second end, and the body portion molded within the bracket thereby coupling the cable to the bracket for transferring a force from the cable to the bracket to slide the sliding panel within the sliding window assembly.

### CROSS-REFERENCE TO RELATED APPLICATIONS

The subject patent application claims priority to and all the benefits of U.S. Provisional Patent Application Ser. No. 61/199,704 which was filed on Nov. 19, 2008, the entire specification of which is expressly incorporated herein by reference.

### BACKGROUND OF THE INVENTION

1. Field of the Invention

The invention generally relates to a sliding panel for a sliding window assembly and, more specifically, to a sliding panel for a sliding window assembly for a vehicle.

2. Description of the Related Art

Sliding window assemblies for vehicles are known in the art. Generally, a sliding window assembly include a first and a second fixed panel configured to be coupled to the vehicle. The first and the second fixed panels are spaced from each other and define an opening therebetween. An upper track and a lower track spaced from the upper track are each attached to the fixed panels. A sliding panel is slideable along the tracks between an open and closed position to modify a size of the opening.

Generally the sliding panel is moved between the open and the closed positions either manually, i.e., by a force applied by a person, or automatically by, for example, a cable drive system including a cable and a motor. When the sliding panel is moved manually, the sliding window assembly is referred to as a manual sliding window assembly. Alternatively, when the sliding panel is moved by the cable and the motor, the sliding window assembly is referred to as a power sliding window assembly. Typically, in the manual sliding window assembly, the sliding panel is disposed directly within the track. In the power sliding window assembly, the sliding panel is disposed within a carrier sleeve that is moveable within the lower track. The cable is coupled to the motor and the carrier sleeve for moving the carrier sleeve which moves the sliding panel between the open and closed positions as the motor is operated.

The required addition of the carrier sleeve in the power sliding window assembly requires the lower track to be wider as compared to if the lower track was used in the manual sliding window assembly. Requiring different lower tracks in the power and manual sliding window assemblies adds considerable cost, labor, and equipment to produce the sliding window assemblies.

It is also know in the art for the sliding window assembly to include a carrier bar in place of the carrier sleeve. Typically, the carrier bar is disposed on the sliding panel for coupling with the cable to move the sliding panel between the open and closed positions. The carrier bar is disposed on the sliding panel by an adhesive that bonds the carrier bar to the sliding panel. Over time, the adhesive can degrade resulting in separation between the carrier bar and the sliding panel and resulting in a failure of the sliding window assembly.

Generally, a diecast cylinder is coupled to each end of the cable, and a portion of the carrier bar defines a pair of pockets for receiving the diecast cylinder to couple the cable to the carrier bar. The complexity of the mechanical interface between the diecast cylinders and the pockets causes the assembly of the sliding window assembly to be labor intensive. Additionally, the portion of the carrier bar defining the pockets can break resulting in a deformation of the pocket and failure of the power sliding window assembly. Furthermore, over time, the diecast cylinder can break off of the cable resulting in a failure of the power sliding window assembly.

### SUMMARY OF THE INVENTION AND ADVANTAGES

The present invention includes a sliding panel for use in a sliding window assembly for a vehicle. The sliding panel has a bottom edge in sliding engagement with the sliding window assembly. The sliding panel includes at least one bracket coupled to the sliding panel. The present invention also includes a cable having a first end and a second end spaced from the first end with a body portion disposed therebetween. At least one of the first end of the cable, the second end of the cable, and the body portion of the cable is molded within the bracket thereby coupling the cable to the bracket. The coupling of the cable to the bracket in this fashion, i.e., by molding, enables transfer of a force from the cable to the bracket to slide the sliding panel within the sliding window assembly once the sliding panel is installed in the sliding window assembly. Molding the cable into the bracket also increases a pull strength between the cable and the bracket as compared to a non-molded connection as with the diecast cylinder and pockets of the carrier bar described above. Furthermore, molding the cable within the bracket increases the durability of the connection between the cable and the bracket thereby extending the life of the sliding window assembly.

The present invention further includes a method of manufacturing the sliding panel. The method includes that step of manipulating a mold assembly into an open position to access a cavity defined by the mold assembly and the step of positioning the cable into the cavity. The method also includes the steps of manipulating the mold assembly into a closed position to secure the cable within the cavity, and injecting a molding material into the cavity to mold the bracket about the cable with at least one of the first end of the cable, the second end of the cable, and the body portion of the cable is molded within the bracket. The method further includes the step of coupling the bracket to the sliding panel to allow the force to be transferred from the cable to the sliding panel to slide the sliding panel within the sliding window assembly. Molding the cable into the bracket during the formation of the bracket decreases an amount of time required to assembly the sliding window assembly because the cable is already coupled to the sliding panel which eliminates an added step of coupling the cable to the sliding window assembly.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 is a perspective view of a vehicle with a sliding window assembly installed on the vehicle;

FIG. 2 is a perspective view of an exterior of the sliding window assembly;

FIG. 3 is a perspective view of an interior of the sliding window assembly;

FIG. 4 is an exploded perspective view of the sliding window assembly;

FIG. 5 is a cross-sectional view taken along line 5-5 of FIG. 3 showing a first track of the sliding window assembly;

FIG. 6 is a cross-sectional view taken along line 6-6 of FIG. 3 showing a second track of the sliding window assembly;

FIG. 7A is a partial perspective view of an interior of a sliding panel for the sliding window assembly;

FIG. 7B is a partial perspective view of an exterior of the sliding panel for the sliding window assembly;

FIG. 8A is a partial view of the sliding panel with a body portion of a cable molded within a bracket coupled to the sliding panel;

FIG. 8B is a partial view of the sliding panel with a first end and a second end of the cable molded within the bracket coupled to the sliding panel;

FIG. 8C is a partial view of the sliding panel with a body portion of a cable molded within a bracket coupled to the sliding panel;

FIG. 9A is a partial view of the sliding panel with a first bracket and a second bracket coupled to the sliding panel and the ends of the cable molded within the brackets;

FIG. 9B is a partial view of the sliding panel with the body portion of the cable molded within the first and second brackets;

FIG. 10 is a partial view of the sliding panel with a mold assembly disposed about a portion of the sliding panel; and

FIG. 11 is a cross-sectional view taken along line 11-11 of FIG. 10 showing a cavity defined by the mold assembly.

### DETAILED DESCRIPTION OF THE EXEMPLARY EMBODIMENT

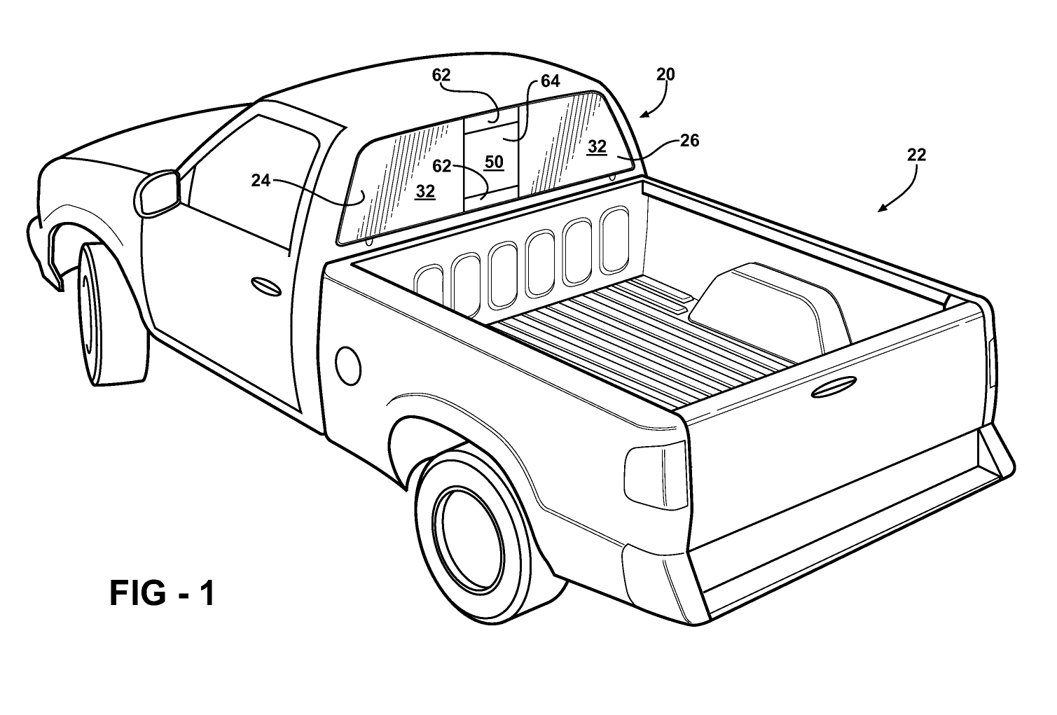

Referring to the Figures, wherein like numerals indicate corresponding parts throughout the several views, a sliding window assembly 20 for use in a vehicle 22 is generally shown. Referring to FIG. 1, the sliding window assembly 20 is shown coupled to the vehicle 22, specifically as a backlite of a pickup truck. However, it is to be appreciated that the sliding window assembly 20 of the present invention can be implemented in other types of vehicles, as well as in non-vehicle applications.

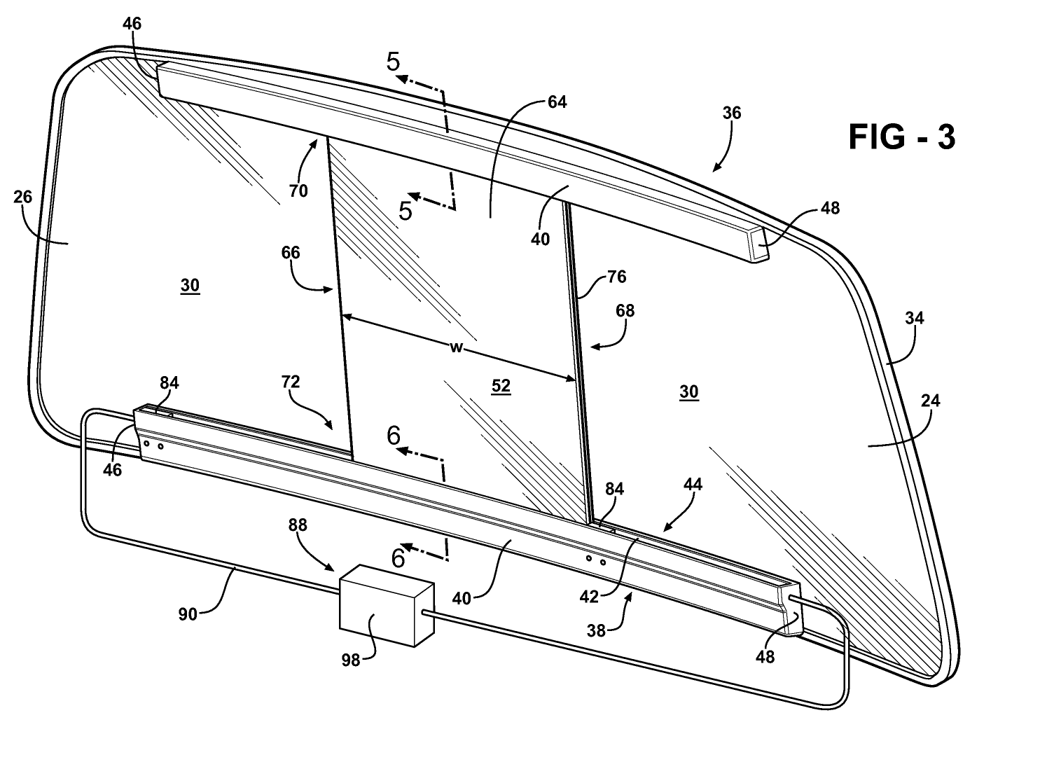

Generally, the sliding window assembly 20 includes at least one fixed panel 24, 26 configured for coupling with the vehicle 22. As shown in FIGS. 1 and 3, the at least one fixed panel 24, 26 includes a first fixed panel 24 and a second fixed panel 26 spaced from the first fixed panel 24 defining an opening 28 therebetween. The first and second fixed panels 24, 26 are typically formed of glass. However, the first and second fixed panels 24, 26 may be formed from any suitable material such as plastic or metal.

The first and second fixed panels 24, 26 have an interior surface 30 for facing an interior of the vehicle 22 when the sliding window assembly 20 is coupled to the vehicle 22. The first and second fixed panels 24, 26 also have an exterior surface 32 for facing an exterior of the vehicle 22 when the sliding window assembly 20 is coupled to the vehicle 22.

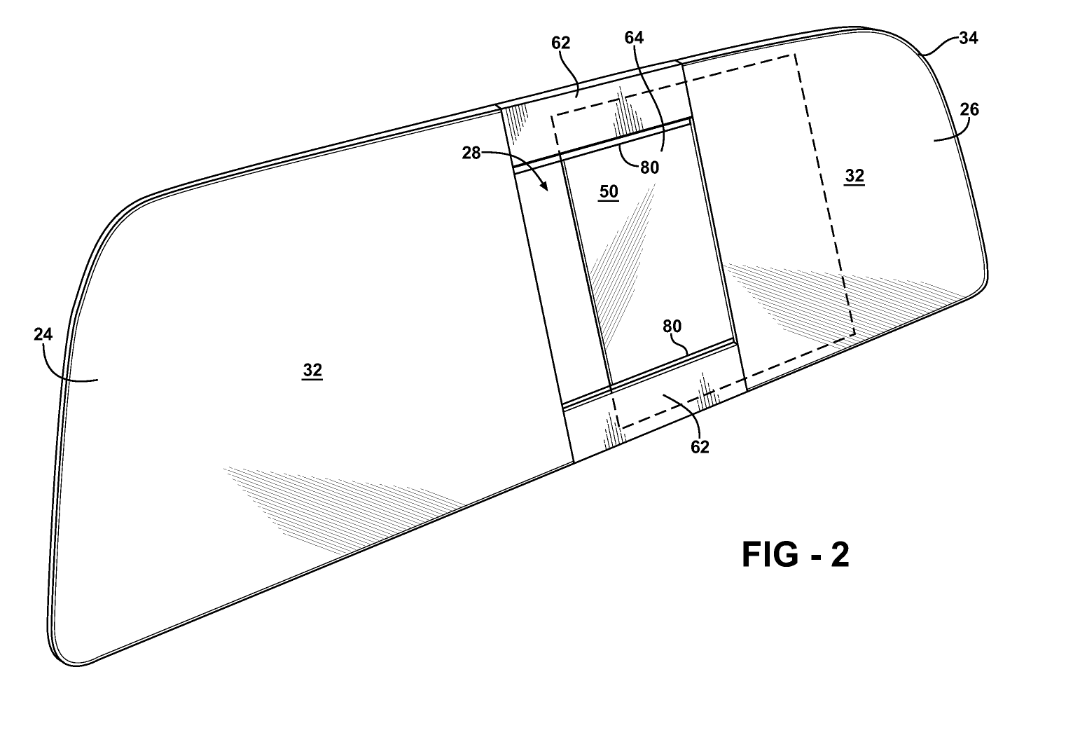

A sliding panel 64 is moveable relative to the first and second fixed panels 24, 26 for covering the opening 28 in a closed position and for uncovering the opening 28 in an open position. The sliding panel 64 is covering the opening 28 in a closed position in FIGS. 1 and 3 and is partially covering the opening 28 between the open and closed positions in FIG. 2. The sliding panel 64 completely uncovers the opening 28 in the open position, which is not shown in the Figures. The sliding panel 64 has a first edge 66 and a second edge 68 spaced from the first edge 66 defining a width W of the sliding panel 64 therebetween. The sliding panel 64 also has a top edge 70 and a bottom edge 72 spaced from the top edge 70. The sliding panel 64 is disposed in an offset relationship to the first and second fixed panels 24, 26. Said differently, the first edge 66 of the sliding panel 64 overlaps the first fixed panel 24 and the second edge 68 of the sliding panel 64 overlaps the second fixed panel 26 when the sliding panel 64 is in the closed position.

The sliding panel 64 presents an exterior surface 50 and an opposing interior surface 52 with the exterior surface 50 of the sliding panel 64 facing the exterior of the vehicle 22 and the interior surface 52 of the sliding panel 64 facing the interior of the vehicle 22 when the sliding window assembly 20 is coupled to the vehicle 22. Like the first and second fixed panels 24, 26, the sliding panel 64 is typically formed of glass, but can be formed of any suitable material such as plastic and metal.

Generally, the sliding window assembly 20 includes at least one track 36, 38, commonly referred to throughout the industry as a run channel. The track 36, 38 is coupled to at least one, and typically both, of the first and second fixed panels 24, 26. As shown in FIG. 3, the at least one track 36, 38 includes a first track 36 coupled to the first and second fixed panels 24, 26 and a second track 38 coupled to the first and second fixed panels 24, 26 spaced from and substantially parallel to the first track 36. The first and second tracks 36, 38 rigidly interconnect the first and second fixed panels 24, 26. The first and second tracks 36, 38 span the opening 28 defined between the first and second fixed panels 24, 26.

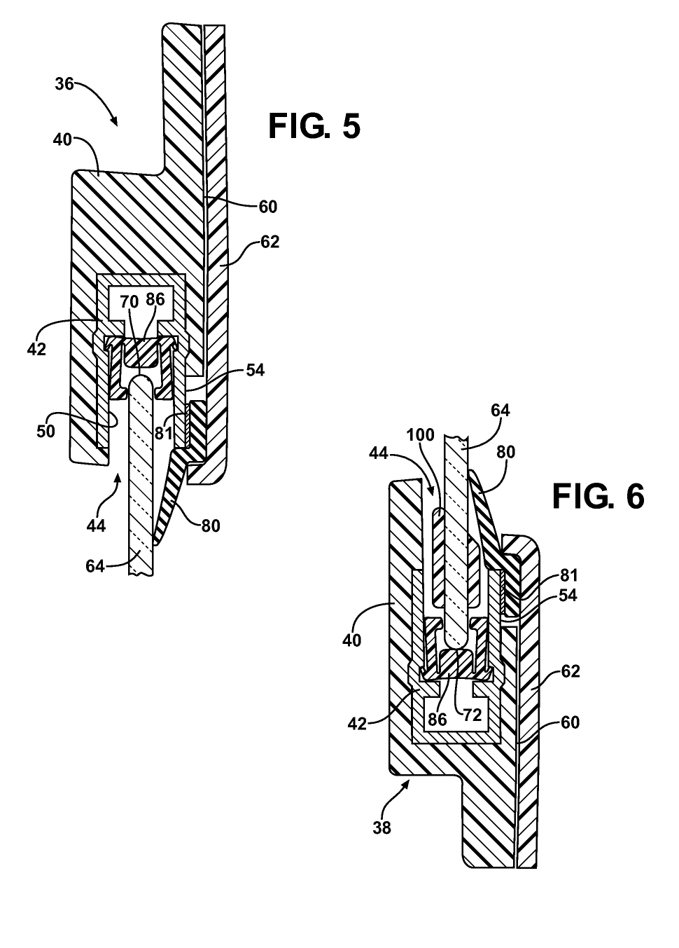

Referring to FIGS. 5 and 6, typically, each of the first and second tracks 36, 38 includes an elongated member 40 and a rail 42 coupled to the elongated member 40. The elongated member 40 is coupled to and extends between the first and second fixed panels 24, 26. The elongated member 40 defines a channel 44 with the rail 42 disposed in the channel 44. It is to be appreciated that the tracks 36, 38 may be manufactured without the elongated member 40 such that the rail 42 is connected directly to the first and second fixed panels 24, 26. Alternatively, the tracks 36, 38 may be manufactured without the rail 42.

The rail 42 provides structural reinforcement to the elongated member 40. The rail 42 has a first end 46 and a second end 48 spaced from the first end 46. The rail 42 is typically U-shaped and has an interior surface 50 and an exterior surface 54. Typically, the rail 42 comprise aluminum however it is to be appreciated that the rail 42 may comprise any suitable material without deviating from the scope of the subject invention.

The first and second tracks 36, 38 are typically coupled to the first and second fixed panels 24, 26 by adhesive surface bonding. Although not required, the adhesive surface bonding can be a process referred to in the industry as glass encapsulation. The glass encapsulation can be further defined as single-sided encapsulation, two-sided encapsulation, or three-sided encapsulation. For example, with single-sided encapsulation, the first and second tracks 36, 38 are coupled to the interior surface 30 of the first and second fixed panels 24, 26 leaving the exterior surface 32 of the first and second fixed panels 24, 26 free of adhesive surface bonding. It should be appreciated that the adhesive surface bonding can be any type of adhesive surface bonding other than glass encapsulation without departing from the nature of the present invention.

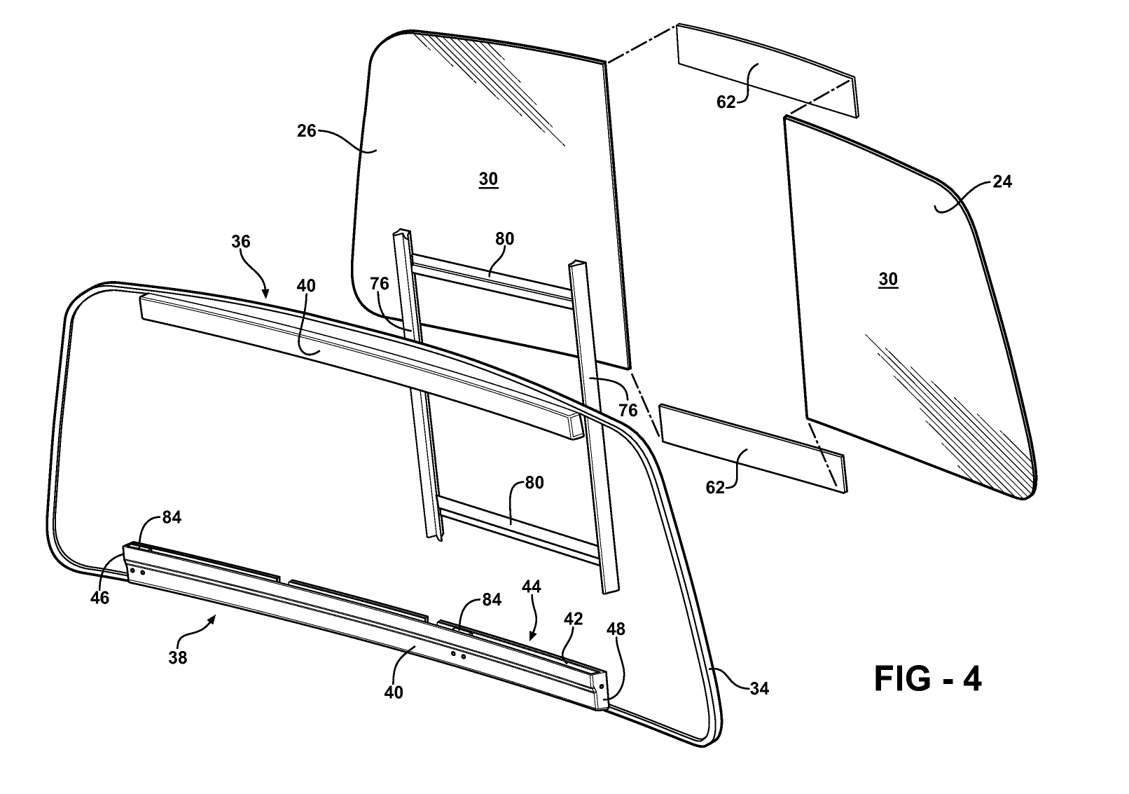

Generally, the glass encapsulation results in an encapsulant that can be used to couple the first and second tracks 36, 38 to the first and second fixed panels 24, 26. When formed by glass encapsulation, the encapsulant typically comprises polyvinyl chloride (PVC). However, it should be appreciated that the encapsulant may be formed from any type of material suitable for glass encapsulation. When the glass encapsulation is employed, the first and second tracks 36, 38 are formed, at least partially, from the encapsulant. Specifically, with respect to glass encapsulation, the elongated member 40 is formed of the encapsulant and is coupled to the first and second fixed panels 24, 26 by glass encapsulation. Furthermore, the rail 42 may also be coupled to the elongated member 40 during the glass encapsulation such that the encapsulant at least partially encompasses the exterior surface 54 of the rail 42. In such an embodiment, the first and second tracks 36, 38 are each integral with the first and second fixed panels 24, 26. Specifically, the elongated member 40 of the first track 36 is integral with the rail 42 of the first track 36 and with the first and second fixed panels 24, 26. Likewise, the elongated member 40 of the second track 38 is integral with the rail 42 of the second track 38 and with the first and second fixed panels 24, 26. In other words, the first and second tracks 36, 38 and the first and second fixed panels 24, 26 form a single continuous unit. It should be appreciated that even though the elongated member 40 and the rail 42 are integral, the elongated member 40 and the rail 42 are shown in an exploded view in FIG. 4 in order to show details of these parts.

As shown in FIGS. 5 and 6, each elongated member 40 presents a mounting surface 60. An applique 62 is mounted to the mounting surface 60 of each elongated member 40. Specifically, the applique 62 is situated in the opening 28 between the first and second fixed panels 24, 26 along the first and second tracks 36, 38. The first and second fixed panels 24, 26 and the applique 62 present exterior surfaces that are substantially flush relative each other. The applique 62 is typically formed of a polycarbonate plastic, but can be formed of other plastics, glass, metal, and the like. In the configuration where the encapsulant is the elongated member 40, the applique 62 is typically attached to the elongated member 40 by glass encapsulation. However, it should be appreciated that the applique 62 may be attached to the elongated member 40 in any fashion, for example by adhesive.

Referring to FIG. 3, the sliding panel 64 is disposed within the first and second tracks 36, 38. The top edge 70 of the sliding panel 64 is received in the channel 44 of the elongated member 40 of the first track 36 and the bottom edge 72 of the sliding panel 64 is received in the channel 44 of the elongated member 40 of the second track 38. The sliding panel 64 is in sliding engagement with the first and second tracks 36, 38 and is slideable along the first and second tracks 36, 38 relative to the first and second fixed panels 24, 26. Generally, the bottom edge 72 of the sliding panel 64 is in sliding engagement with the second track 38. The first and second tracks 36, 38 guide the sliding panel 64 as the sliding panel 64 moves between the closed and open positions.

The sliding panel 64 typically slides horizontally along the first and second tracks 36, 38, but it should be appreciated that the sliding panel 64 can also slide in other directions, e.g. vertically, without departing from the nature of the present invention. In FIG. 3 the sliding panel 64 slides to the left to the open position and slides to the right to the closed position, but it should be appreciated that the sliding panel 64 can slide in any direction between the open and closed position without departing from the nature of the present invention. It should also be appreciated that the sliding panel 64 can slide in more than one direction from the closed to the open positions. Typically, when the sliding panel 64 is moveable horizontally, the first and second tracks 36, 38 extend generally horizontally along the periphery of the first and second fixed panels 24, 26. Alternatively, when the sliding panel 64 is moveable vertically, the first and second tracks 36, 38 extend generally vertically between the periphery of the first and second fixed panels 24, 26.

As shown in FIG. 4, the sliding window assembly 20 includes a pair of vertical seals 76 and a pair of horizontal seals 80 for collectively sealing the sliding panel 64 relative to the first and second fixed panels 24, 26 and the first and second tracks 36, 38. Each of the vertical seals 76 is coupled to a respective one of the first and second fixed panels 24, 26 between the first and second tracks 36, 38. The vertical seals 76 contact the sliding panel 64 when the sliding panel 64 is in the closed position. When the sliding panel 64 is in the open position, only one of the vertical seals 76 contacts the sliding panel 64. Each of the horizontal seals 80 is coupled to a respective one of the first and second tracks 36, 38 and contacts the sliding panel 64. It is to be appreciated that the horizontal seals 80 contact the sliding panel 64 when the sliding panel 64 is in the open position, closed position or any position in between. Typically, the vertical seals 76 and one of the horizontal seals 80 are integral with each other such that the vertical seals 76 and one of the horizontal seals 80 is a one-piece seal. When the one-piece seal is employed, the horizontal seal 80 coupled to the first track 36 is included in the one-piece seal. It is to be appreciated that the vertical seals 76 and both the horizontal seals 80 may be integral with one another without departing from the scope of the present invention. It is also to be appreciates that each of the vertical seals 76 and the horizontal seals 80 may be discrete components relative to each other,

The vertical and horizontal seals 76, 80 are typically coupled, e.g. adhered, to the first and second fixed panels 24, 26 and the first and second tracks 36, 38 with an attachment element 81, such as a tape, an adhesive film or an encapsulant. However, it should be appreciated that the vertical and horizontal seals 76, 80 may be coupled to the first and second fixed panels 24, 26 and the tracks 36, 38 in any fashion. The vertical and horizontal seals 76, 80 are formed of any suitable material without departing from the nature of the present invention. For example, the vertical and horizontal seals 76, 80 are preferably ethylene propylene diene monomer. Alternatively, for example, the vertical seal 76 and the horizontal seal 80 are thermoplastic vulcanizates or thermoplastic elastomer. Typically, the vertical and horizontal seals 76, 80 are applied after the adhesive surface bonding, e.g. the glass encapsulation of the first and second tracks 36, 38 to the first and second fixed panels 24, 26, but can be applied at any time.

Referring to FIG. 3, a pair of stopping blocks 84 are disposed in the first and the second tracks 36, 38 for limiting the movement of the sliding panel 64 such that the first edge 66 of the sliding panel 64 contacts one of the stopping blocks 84 when in the open position and the second edge 68 contacts another one of the stopping blocks 84 when in the closed position.

Although not required, FIGS. 5 and 6 show a channel insert 86 fixed within each of the first and the second tracks 36, 38. When the channel insert 86 is present, at least the bottom edge 72 of the sliding panel 64 is in sliding engagement with the channel insert 86 and the sliding panel 64 is slidable along the channel insert 86. The channel insert 86 reduces a coefficient of friction between the sliding panel 64 and the tracks 36, 38 for reducing a work required to move the sliding panel 64 between the open and closes positions. The channel insert 86 is fixed within the first and second tracks 36, 38 to prevent the channel insert 86 from moving along the first and second tracks 36, 38.

Referring to FIGS. 2 and 3, although not required, the sliding window assembly can include a frame member 34 surrounding a periphery of the first and second fixed panels 24, 26. The frame member 34 may be integral with the first and second tracks 36, 38. The frame member 34 can comprise any suitable material such as plastic and metal.

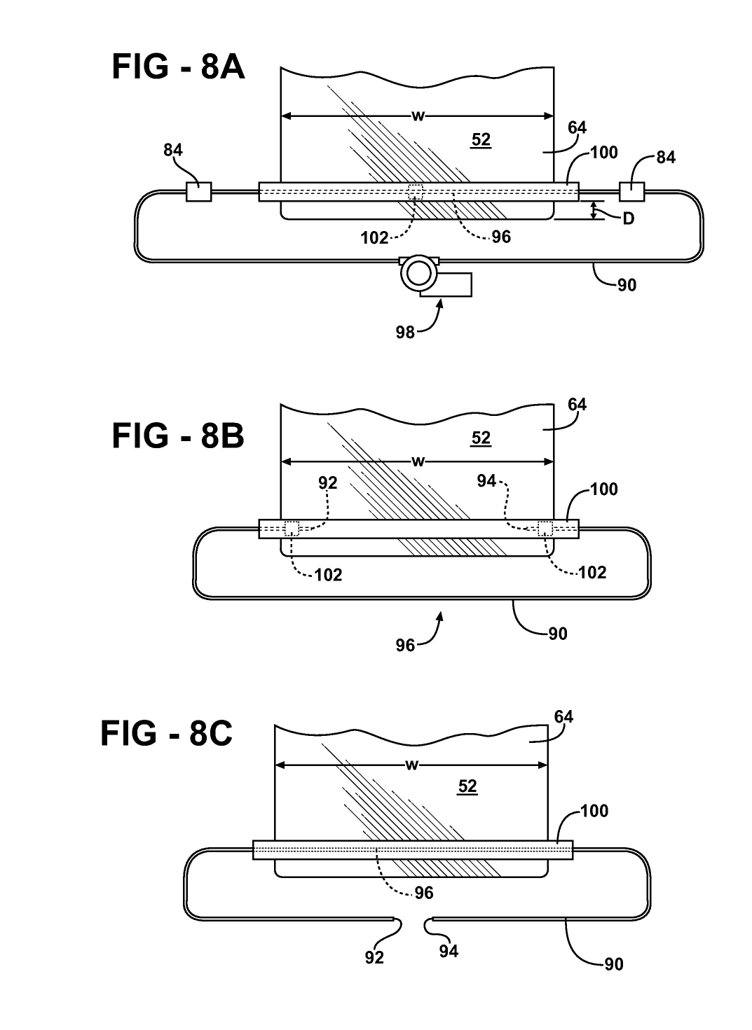

Referring to FIG. 3, the sliding window assembly 20 includes a cable drive system 88 commonly referred to throughout the industry as a pull-pull cable drive system for moving the sliding panel 64 between the open and the closed positions. The cable drive system 88 includes at least one cable 90. Referring to FIGS. 8A trough 8C, the cable 90 has a first end 92 and a second end 94 spaced from the first end 92 and a body portion 96 disposed therebetween. The cable drive system 88 also includes a motor 98, such as a linear motor, with the cable 90 coupled to the motor 98. The motor 98 rotates for winding the cable 90 about the motor 98 in the direction of rotation, i.e., clockwise or counterclockwise. The cable 90 is also coupled to the sliding panel 64 for moving the sliding panel 64 as the motor 98 rotates. More specifically, when the motor 98 rotates clockwise, tension on the cable 90 applies a force to the sliding panel 64 in a direction to modify the size of the opening 28, i.e., the sliding panel 64 slides from the closed position to the open position, or from the open position to the closed position. The sliding panel 64 slides back in an opposite direction when the motor 98 is rotated counterclockwise. The force applied to the sliding panel 64 through tension on the cable 90 is of from about 40 to about 50 kilogram-force (kgf). The motor 98 is selected based on a maximum torque of the motor 98, which results in the force described above. For safety, the force typically does not exceed 50 kgf.

The sliding window assembly 20 includes at least one bracket 100 for coupling the cable 90 to the sliding panel 64. The bracket 100 transfers the force from the cable 90 to the sliding panel 64 for sliding the sliding panel 64 within the sliding window assembly 20. Generally, the sliding panel 64 is disposed on the sliding panel 64 proximate to the bottom edge 72 of the sliding panel 64. Typically, the bracket 100 is within the channel 44 below the horizontal seal 80 such that the horizontal seal 80 prevents the environmental elements from contacting the sliding panel 64. The bracket 100 is spaced a distance D typically of from about 1 to about 15, more typically from about 2 to about 10, and even more typically about 5 millimeters. Spacing the bracket 100 from the bottom edge 72 of the sliding panel 64 allows the bottom edge 72 of the sliding panel 64 is in sliding engagement with the second track 38. Allowing the bottom edge 72 of the sliding panel 64 to engage the second track 38 eliminates the need for a carrier sleeve which eliminates the need for different tracks for power sliding window assemblies as compared to manual sliding window assemblies.

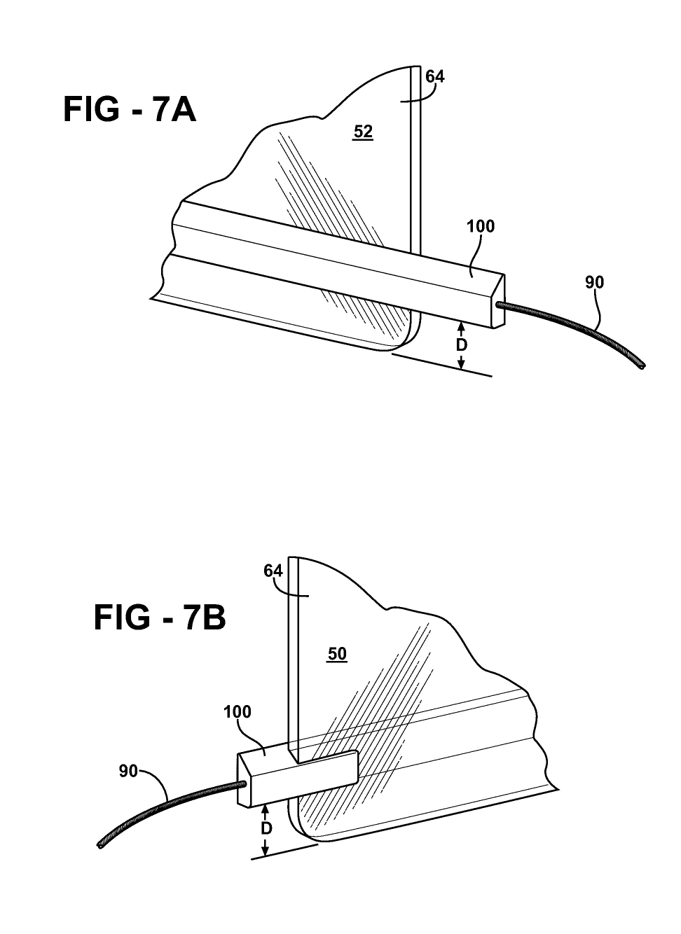

The bracket 100 is substantially parallel to the bottom edge 72 of the sliding panel 64 and spans the entire width W of the sliding panel 64. Said differently, the bracket 100 runs along the bottom edge 72 of the sliding panel and extends past both the first edge 66 and the second edge 68 of the sliding panel 64. The bracket 100 is disposed on the interior surface 52 of the sliding panel 64. It is to be appreciated that the bracket 100 may be disposed on only the interior surface 52 of the sliding panel 64. Alternatively, the bracket 100 may be disposed on the interior surface 52 of the sliding panel 64 and one of the edges 66, 68 of the sliding panel 64. Furthermore, the bracket 100 may be disposed on both the exterior and interior surfaces 50, 52 and one of the edges 66, 68, as shown in FIGS. 7A and 7B.

The bracket 100 is molded from a molding material. The bracket 100 may be molded by any method known in the art such as injection molding and reaction injection molding. Additionally, when the bracket 100 is molded directly to the sliding panel 64, the bracket 100 is molded by glass encapsulation similar to the tracks 36, 38 as described above. When glass encapsulation is employed to form the bracket 100, the bracket 100 comprises the encapsulant that results from the glass encapsulation. It is to be appreciated that a primer may be applied to the sliding panel 64 prior to molding the bracket 100 for increasing a bond strength between the bracket 100 and the sliding panel 64. Alternatively, the bracket 100 can be molded without the sliding panel 64 present and subsequently coupled to the sliding panel 64 by an adhesive.

When injection molding in employed to mold the bracket 100, the molding material typically comprises a thermoplastic material, and more typically comprises polyvinyl chloride (PVC). When reaction injection molding is employed to mold the bracket 100, the molding material typically comprises a thermoset polymer, and more typically comprises an isocyanate component and an isocyanate-reactive component, and even more typically comprises a polyurethane. An example of suitable polyurethanes, for the purposes of the present invention, are commercially available from BASF Corporation under the tradename of COLO-FAST™, e.g. COLO-FAST LM-161. However, it is to be appreciated that the molding material may comprise any suitable material for molding the bracket 100.

With reference to the bracket 100, the glass encapsulation can be further defined as single-sided glass encapsulation, double-sided encapsulation, or triple-sided encapsulation. Preferably, triple-sided encapsulation is employed which results in the bracket 100 being disposed on both the exterior and interior surfaces 50, 52 of the sliding panel 64 and the edges 66, 68 of the sliding panel 64, as shown in FIGS. 7A and 7B. Triple-sided encapsulation increases a surface area of the sliding panel 64 that the bracket 100 is coupled to while limiting a size of the bracket 100. The increased surface area increases bond strength between the bracket 100 and the sliding panel 64 and limiting the size of the bracket 100 provides an aesthetically pleasing appearance.

At least one of the first end 92 of the cable 90, the second end 94 of the cable 90, and the body portion 96 of the cable is molded within the bracket 100. In other words, the first end 92 of the cable 90 by itself can be molded into the bracket 100, the second end 94 of the cable 90 by itself can be molded into the bracket 100, or the body portion 96 of the cable 90 by itself can be molded into the bracket 100. Additionally, combination of the first end 92 of the cable 90, the second end 94 of the cable 90, and the body portion 96 of the cable 90 can be molded into the bracket 100. The cable 90 is molded into the bracket 100 for coupling the cable 90 to the bracket 100 for transferring the force from the cable 90 to the bracket 100 to slide the sliding panel 64 along the tracks 36, 38. Generally, the cable 90 is molded into the bracket 100 as the bracket 100 is molded. Said differently, the molding material encapsulates the cable 90 resulting in the formation of the bracket 100 about the cable 90. Molding the cable 90 into the bracket 100 provides a strong bond between the cable 90 and the bracket 100 that does not degrade over time which extends a life of the sliding window assembly 20. Additionally, the strong bond between the cable 90 and the bracket 100 prevents the cable 90 from being pulled out of the bracket 100 when the force is transferred to from the cable 90 to the bracket 100 for moving the sliding panel 64. Typically, molding the cable 90 within the bracket 100 provides a pull strength of from about 50 to about 200, more typically from about 80 to about 180, and most typically from about 80 to 100 kgf. As described above, the force applied to the bracket 100 typically does not exceed 50 kgf. Therefore, the pull strength achieved by molding the cable 90 within the bracket 100 exceeds the force typically applied to the bracket 100.

Referring to FIG. 8A showing the body portion 96 of the cable 90 molded within the bracket 100, the cable 90 spans the entire width W of the sliding panel 64 within the bracket 100. The ends 92, 94 of the cable 90 are coupled to the motor 98 for pulling the cable 90 to move the sliding panel 64 between the open and the closed positions as discussed above. Referring to FIG. 8B, the ends 92, 94 of the cable 90 are molded within the bracket 100 and the cable 90 only spans a portion of the width W of the sliding panel 64. When the ends 92, 94 of the cable 90 are molded within the bracket 100, the body portion is coupled to the motor 98 for pulling the cable 90 to move the sliding panel 64 between the open and the closed positions.

Referring to FIGS. 8A and 8B, although not required, the cable 90 may include an anchor 102. Generally, the anchor 102 increases a surface of the bracket 100 that the cable 90 acts against for increasing the pull strength between the cable 90 and the bracket 100. It is to be appreciated that the anchor 102 can be an integral portion of the cable 90 or the anchor 102 can be a discrete component relative to the cable 90. When the anchor 102 is the integral portion of the cable 90, at least one of the first end 92, the second end 94 and the body portion 96 of the cable 90 has the anchor 102 depending on which of the first end 92, the second end 94 and the body portion 96 of the cable 90 is molded within the bracket 100. For example, when the first end 92 of the cable 90 is molded within the bracket 100, the first end 92 may include the anchor 102. Alternatively, when the body portion 96 of the cable 90 is molded within the bracket 100, the body portion 96 may have the anchor 102. When the anchor 102 is the integral portion of the cable 90, the anchor 102 may be formed by crimping the cable 90 or the anchor 102 may be formed by looping the cable 90 within the bracket 100 such that the cable 90 doubles back upon itself.

When the anchor 102 is the discrete component, the anchor 102 may be coupled to the cable 90, which, in effect, increases the surface area of the bracket 100 the cable 90 acts against. For example, the anchor 102 may be a washer or a grommet connected to the cable 90. It is to be appreciated that the anchor 102 may be coupled to the cable 90 outside of the bracket 100 and contact an exterior of the bracket 100 as the cable 90 applies the force to the bracket 100. The anchor 102 may comprise any suitable material such as metal, and plastic.

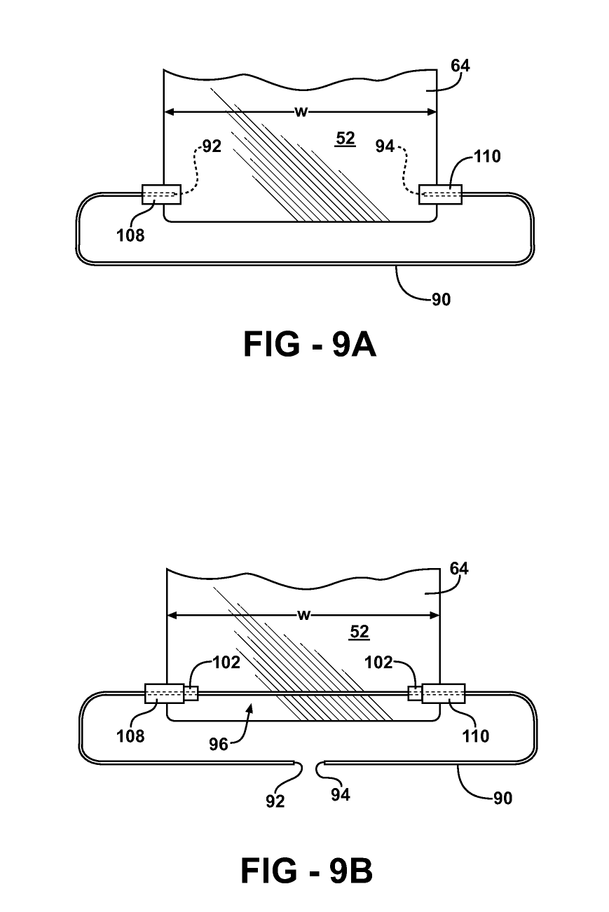

Referring to FIGS. 9A and 9B, the at least one bracket 100 may be a first bracket 108 coupled to the sliding panel 64 and a second bracket 110 coupled to the sliding panel 64 spaced from the first bracket 108. When the first and second brackets 108, 110 are employed, at least one of the first end 92 of the cable 90, the second end 94 of the cable 90, and the body portion 96 of the cable 90 are molded within the brackets 108, 110. Specifically, the body portion 96 of the cable 90 may be molded within the brackets 108, 110 as shown in FIG. 9B. Alternatively, the ends 92, 94 of the cable 90 may be molded within a respective one of the brackets 108, 110 as shown in FIG. 9A.

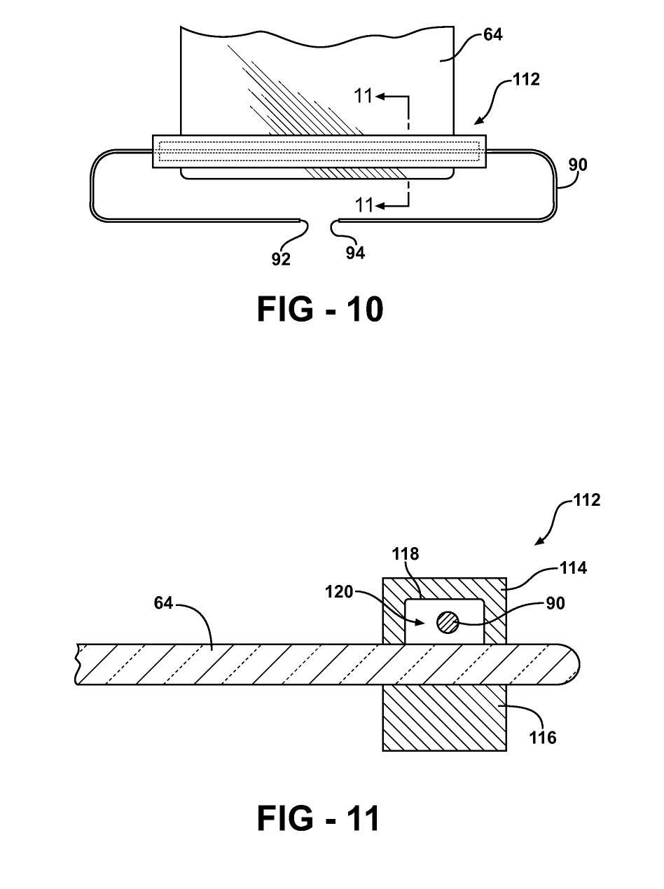

The following is a description of a method of manufacturing the sliding panel 64 for use in the sliding window assembly 20. The method of manufacturing the sliding panel 64 includes the use of a mold assembly 112, as shown in FIGS. 10 and 11. For example, the mold assembly 112 has a first mold portion 114 and a second mold portion 116 spaced from each other. Each of the first and second mold portions 114, 116 has a mold surface 118 defining a cavity 120. The first and second mold portions 114, 116 are moveable relative to each other to move the mold assembly 112 between an open position that allows access to the cavity 120 and a closed position that seals the cavity 120.

The method includes the steps of manipulating the mold assembly 112 into the open position to access the cavity 120 defined by the mold assembly 112 and positioning the cable 90 into the cavity 120. Typically, when the cable 90 is positioned into the cavity 120, the cable 90 is spaced from the mold surface 118. The method also includes the steps of manipulating the mold assembly 112 into the closed position to secure the cable 90 within the cavity 120 and injecting the molding material into the cavity 120 to mold the bracket 100 about the cable 90 with at least one of the first end 92, the second end 94, and the body portion 96 molded within the bracket 100. It is to be appreciated that the step of injecting a molding material may be further defined as injecting the isocyanate component and the isocyanate-reactive component into the cavity 120 to mold the bracket 100 about the cable 90. The molding material is allowed to solidify within the mold assembly 112 thereby forming the bracket 100. Molding the cable into the bracket during the formation of the bracket decreases an amount of time required to assembly the sliding window assembly because the cable is already coupled to the sliding panel which eliminates an added step of coupling the cable to the sliding window assembly.

The method further includes the step of coupling the bracket 100 to the sliding panel 64 to allow the force to be transferred from the cable 90 to the sliding panel 64 to slide the sliding panel 64 within the sliding window assembly 20. The method may include the step of applying an adhesive to the bracket 100 prior to the step of coupling the bracket 100 to the sliding panel 64. Alternatively, the step of injecting the molding material into the cavity 120 and the step of coupling the bracket 100 to the sliding panel 64 may be preformed simultaneously such that the bracket 100 is formed by glass encapsulation. For example, when the bracket 100 is formed by glass encapsulation, the molding material is allowed to solidify within the mold assembly 112 thereby forming the bracket 100 and bonding the bracket 100 to both the sliding panel 64 and the cable 90. As such, the method may also include the step of positioning the sliding panel 64 within the mold assembly 112 adjacent the cable 90 with the cavity 120 of the mold assembly 112 spaced from the bottom edge 72 of the sliding panel 64 prior to the step of manipulating the mold assembly 112 into the closed position. The method may also include the step of manipulating the mold assembly 112 into the open position to remove the sliding panel 64 from the mold assembly 112. When the anchor 102 is employed, the method may include the step of forming the anchor 103 in least one of the first end 92, the second end 94, and the body portion 96 of the cable 90 that is to be molded within the bracket 100 prior to manipulating the mold assembly 112 into the close position. When the anchor 102 is employed, the method may include the step of coupling the anchor 102 to the cable 90 prior to positioning the cable 90 into the cavity 120.

Referring to FIGS. 9A and 9B, when the sliding panel 64 included the first and second brackets 108, 110, the mold assembly 112 defines a pair of cavities 120′. In such a configuration, the method step of injecting the molding material into the cavity 120 is further defined as injecting the molding material into the pair of cavities 120′ to mold the first bracket 108 and the second bracket 110.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sliding window assembly for a vehicle, said sliding window assembly comprising:
at least one fixed panel configured for coupling with the vehicle;
at least one track coupled to said fixed panel;
a sliding panel having a bottom edge in sliding engagement with said track;
at least one bracket coupled to said sliding panel; and
a cable having a first end and a second end spaced from said first end and a body portion disposed therebetween with at least one of said first end, said second end, and said body portion molded within said bracket thereby coupling said cable to said bracket for transferring a force from said cable to said bracket to slide said sliding panel along said track.

2. A sliding window assembly as set forth in claim 1 wherein said bracket is substantially parallel to said bottom edge of said sliding panel and spans an entire width of said sliding panel.

3. A sliding window assembly as set forth in claim 2 wherein said body portion of said cable is molded within said bracket.

4. A sliding window assembly as set forth in claim 2 wherein said first and said second ends of said cable are molded within said bracket.

5. A sliding window assembly as set forth in claim 1 wherein said at least one bracket includes a first bracket coupled to said sliding panel and a second bracket coupled to said sliding panel spaced from said first bracket.

6. A sliding window assembly as set forth in claim 5 wherein said first end of said cable is molded within said first bracket and said second end of said cable is molded within said second bracket.

7. A sliding window assembly as set forth in claim 5 wherein said body portion of said cable is molded within said first and second brackets.

8. A sliding window assembly as set forth in claim 1 wherein said bracket is spaced a distance of from about 1 to about 15 millimeters from said bottom edge of said sliding panel for allowing said bottom edge to be in direct sliding engagement with said track.

9. A sliding window assembly as set forth in claim 1 wherein said track has an elongated member and a rail disposed within said elongated member with said bottom edge of said sliding panel in direct sliding engagement with said rail.

10. A sliding window assembly as set forth in claim 9 further comprising a channel insert disposed within said rail with said bottom edge of said sliding panel in direct sliding engagement with said channel insert.

11. A sliding window assembly as set forth in claim 1 wherein said cable molded within said bracket provides a pull strength of from about 50 to about 200 kilogram-force without said cable separating from said bracket.

12. A sliding window assembly as set forth in claim 1 wherein at least one of said first end, said second end, and said body portion of said cable includes an anchor molded within said bracket for increasing a surface area of said cable molded within said bracket thereby improving a bond between said cable and said bracket.

13. A sliding window assembly as set forth in claim 1 wherein said bracket is an encapsulant coupled to said sliding panel by encapsulation.

14. A sliding panel for use in a sliding window assembly for a vehicle, said sliding panel comprising:
a bottom edge in sliding engagement with the sliding window assembly;
at least one bracket coupled to said sliding panel; and
a cable having a first end and a second end spaced from said first end with a body portion disposed therebetween with at least one of said first end, said second end, and said body portion molded within said bracket thereby coupling said cable to said bracket for transferring a force from said cable to said bracket to slide said sliding panel within the sliding window assembly.

15. A sliding window assembly as set forth in claim 14 wherein said bracket is substantially parallel to said bottom edge of said sliding panel and spans an entire width of said sliding panel.

16. A sliding window assembly as set forth in claim 15 wherein said body portion of said cable is molded within said bracket.

17. A sliding window assembly as set forth in claim 15 wherein said first and said second ends of said cable are molded within said bracket.

18. A sliding window assembly as set forth in claim 14 wherein said at least one bracket includes a first bracket coupled to said sliding panel and a second bracket coupled to said sliding panel spaced from said first bracket.

19. A sliding window assembly as set forth in claim 18 wherein said first end of said cable is molded within said first bracket and said second end of said cable is molded within said second bracket.

20. A sliding window assembly as set forth in claim 18 wherein said body portion of said cable is molded within said first and second brackets.

21. A sliding window assembly as set forth in claim 14 wherein said bracket is spaced a distance of from about 1 to about 15 millimeters from said bottom edge of said sliding panel for allowing said bottom edge to be in direct sliding engagement with said track.

22. A sliding window assembly as set forth in claim 14 wherein said track has an elongated member and a rail disposed within said elongated member with said bottom edge of said sliding panel in direct sliding engagement with said rail.

23. A sliding window assembly as set forth in claim 21 further comprising a channel insert fixed within said rail with said bottom edge of said sliding panel in direct sliding engagement with said channel insert.

24. A sliding window assembly as set forth in claim 14 wherein said cable molded within said bracket provides a pull strength of from about 50 to about 200 kilogram-force without said cable separating from said bracket.

25. A sliding window assembly as set forth in claim 14 wherein at least one of said first end, said second end, and said body portion of said cable includes an anchor molded within said bracket for increasing a surface area of said cable molded within said bracket thereby improving a bond between said cable and said bracket.

26. A sliding window assembly as set forth in claim 14 wherein said bracket is an encapsulant coupled to said sliding panel by encapsulation.

27. A method of manufacturing a sliding panel for use in a sliding window assembly for a vehicle, said method comprising the steps of:
manipulating a mold assembly into an open position to access a cavity defined by the mold assembly;
positioning a cable into the cavity with the cable having a first end and a second end spaced from the first end with a body portion disposed therebetween;
manipulating the mold assembly into a closed position to secure the cable within the cavity;
injecting a molding material into the cavity to mold a bracket about the cable with at least one of the first end, the second end, and the body portion of the cable molded within the bracket; and
coupling the bracket to the sliding panel to allow a force to be transferred from the cable to the sliding panel to slide the sliding panel within the sliding window assembly.

28. A method as set forth in claim 27 wherein the step of injecting a molding material into the cavity and the step of coupling the bracket to the sliding panel are preformed simultaneously such that the bracket is formed by glass encapsulation.

29. A method as set forth in claim 27 wherein said step of injecting a molding material is further defined as injecting an isocyanate component and an isocyanate-reactive component into the cavity to mold a bracket about the cable with at least one of the first end, the second end, and the body portion molded within the bracket.

30. A method as set forth in claim 27 further comprising the step of positioning the sliding panel within the mold assembly adjacent the cable with the cavity of the mold assembly spaced from a bottom edge of the sliding panel prior to the step of manipulating the mold assembly into a closed position.

31. A method as set forth in claim 27 wherein the mold assembly defines a pair of cavities and the step of injecting a molding material into the cavity is further defined as injecting a molding material into the pair of cavities to mold a first bracket and a second bracket with the first end of the cable molded within the first bracket and the second end of the cable molded within the second bracket.

32. A method as set forth in claim 27 further comprising the step of manipulating the mold assembly into the open position to remove the sliding panel from the mold assembly.

33. A method as set forth in claim 27 further comprising the step of applying an adhesive to the bracket prior to the step of coupling the bracket to the sliding panel.

34. A method as set forth in claim 27 further including the step of manipulating the cable to form an anchor in least one of the first end, the second end, and the body portion of the cable that is to be molded within the bracket prior to manipulating the mold assembly into the close position.
